(19) United States
(12) Patent Application Publication
(10) Pub. No.: US 2026/0365365 A1
(43) Pub. Date: Nov. 19, 2026

(54) A FLUID DISPENSER AND A PROCESS OF MAKING A FLUID DISPENSER

(71) Applicant: PARKSONS PACKAGING LTD., Chakan, Pune (IN)

(72) Inventor: Jerry George BACHNER, Crystal Lake, IL (US)

(21) Appl. No.: 19/130,934

(22) PCT Filed: Nov. 29, 2023
(86) PCT No.: PCT/IB2023/062003

§ 371 Date: May 16, 2025

(30) Foreign Application Priority Data
Nov. 29, 2022 (IN) 202221068726

(51) Int. Cl. B65D 5/74; B05B 11/00; B05B 11/10; B65D 5/06; B65D 5/40; B65D 5/42; B65D 5/56

(52) U.S. Cl. CPC B65D 5/746; B05B 11/0037; B05B 11/1045; B65D 5/06; B65D 5/4208; B65D 5/4266; B65D 5/563; B65D 5/40

(57) ABSTRACT

The present disclosure relates to and envisages a fluid dispenser (10) comprising a carton (100) configured to store fluid therein. The carton (100) is of a laminated recyclable substrate having a set of fold lines configured thereon. The substrate is configured to be folded along the fold lines to form a flat base (135), side panels (125A, 125B, 125C, 125D), and a substantially rigid flat top of the carton (100). A fitment hole (110) is configured on the first top panel (130A). A fitment unit is mounted on the fitment hole (110) to facilitate fluid dispensation therethrough.

### FIELD

The present disclosure generally relates to fluid dispensing packaging.

### DEFINITION

Fluid: The term ‘fluid’ hereinafter refers to fluids, liquids or slurries including semi-viscous material such as gels, soap slurries, creams and lotions.

### BACKGROUND

The background information herein below relates to the present disclosure but is not necessarily prior art.

Nowadays, to lower the hazardous effects of plastic, products are packed in packaging made of recyclable material which could be plant-based or starch-based materials, cardboards, virgin or recycled papers. However, hitherto it has not been possible to practically make dispensers out of these materials because such materials can easily be deformed, especially when forces are applied thereon. Further, packaging made of recyclable material does not allow storage of fluids for a very long period of time as the fluid seeps into the material.

There is therefore felt a need for a dispenser that can be industrially made with recyclable materials to alleviate the aforementioned drawbacks.

### Objects

Some of the objects of the present disclosure, which at least one embodiment herein satisfies, are as follows:

It is an object of the present disclosure to ameliorate one or more problems of the prior art or to at least provide a useful alternative.

One object of the present disclosure is to provide a fluid dispenser.

Another object of the present disclosure is to provide a fluid dispenser that can be industrially manufactured.

Yet another object of the present disclosure is to provide a fluid dispenser that can be manufactured on automatic machines.

Still another object of the present disclosure is to provide a fluid dispenser that is manufactured from recyclable materials.

Another object of the present disclosure is to provide a process for making a fluid dispenser.

Another object of the present disclosure is to provide a process for making a fluid dispenser which allows manufacturing of the dispenser in a simplified manner in an automatic machine.

Other objects and advantages of the present disclosure will be more apparent from the following description when read in conjunction with the accompanying figures, which are not intended to limit the scope of the present disclosure.

### SUMMARY

The present disclosure envisages a fluid dispenser. The fluid dispenser comprises a carton configured to store fluid therein. The carton is formed from a laminated blank folded to form a set of sections which in their operative folded configuration are folded towards each other using a machine folding process to form base panels, side panels and top panels of the carton.

The fluid dispenser further comprises a fitment hole configured on the first top panel, and a fitment unit mounted on the fitment hole to facilitate fluid dispensation therethrough.

The present disclosure further envisages a process for making a fluid dispenser. The method comprises the following steps:
preparing a blank from a laminated recyclable substrate;
punching a fitment hole at a predetermined location on an operative top portion of said blank;
stamping a set of first fold lines on said blank, such that said first fold lines extend from an operative top edge of said blank to an operative bottom edge thereof,
stamping a set of second fold lines on an operative bottom portion of said blank;
stamping a set of third fold lines on said operative top portion of said blank;
stamping a depression on a first fold line;
folding said set of first fold lines, by a machine folding process, to define side panels;
securing longitudinal edges of end side panels with each other to form an open carton;
folding said set of second fold lines in a predetermined sequence to form a pair of base panels;
folding said first base panel over said second base panel;
heat sealing said bottom flaps with each other to form a closed base of said carton;
mounting a fitment unit on said fitment hole;
filling said carton with a predetermined volume of a fluid;
folding said set of third fold lines in a predetermined sequence to define a pair of top panels;
heat sealing said top panels with each other;
displacing said top panels in an operative downward direction such that said first top panel overlaps said second top panel and defines a pair of ear flaps extending therefrom;
abutting said ear flaps with said side panels, and heat sealing said ear flaps with said side panels to define a substantially rigid flat top of said carton.

### BRIEF DESCRIPTION OF THE ACCOMPANYING DRAWING

A fluid dispenser, in accordance with the present disclosure, will now be described with the help of the accompanying drawing, in which:

FIG. 1 illustrates the fluid dispenser, in accordance with an embodiment of the present disclosure;

FIG. 2 illustrates an exploded view of the dispenser of FIG. 1;

FIG. 3 illustrates a blank for the dispenser of FIG. 2;

FIG. 4 illustrates the blank of FIG. 3 in a partly folded configuration;

FIG. 5 illustrates the blank of FIG. 4 further folded into a sleeve;

FIG. 6 illustrates the sleeve of FIG. 5, being open with its side panels completely unfolded and its short side panel sealed to the other outside panel.

FIG. 7 illustrates the sleeve of FIG. 6, with the bottom portions of the side panels in a partially folded configuration;

FIG. 8 illustrates the sleeve of FIG. 7, with the bottom portions of the side panels in a further folded configuration;

FIG. 9 illustrates the sleeve of FIG. 8, with the bottom portions of the side panels partly folded such that the bottom portion of one side panel overlaps the bottom portion of the other side panel;

FIG. 10 illustrates the sleeve of FIG. 9, with the bottom portions of the side panels folded and sealed forming a flat surface to define the carton bottom with an open top;

FIG. 11 and FIG. 12 illustrates the open carton of FIG. 10, with the top portions of the side panels having their folds defined outward;

FIG. 13 illustrates the open carton of FIG. 11, with a fitment and cap unit attached to the top portion of one of the side panels of the carton prior to filling the carton with fluids;

FIG. 14 illustrates the open carton of FIG. 13, with the top portions of the side panels ready to be folded together to close and top seal the carton;

FIG. 15 through FIG. 19 illustrate the carton of FIG. 14, with a top portion of a first side panel, having the fitment and cap unit, overlapping a top portion of a second side panel and about to be folded and pressed on the top portion of the second panel;

FIG. 20 through FIG. 24 illustrate the carton of FIG. 19, with the top portion of the first side panel attached to the top portion of the second side panel to form the flat top of the carton;

FIG. 25 illustrates the carton of FIG. 24, with the ears of the top portions of the side panels fixed to the body of the side panels to prepare the carton;

FIG. 26 illustrates an isometric exploded view of a carton, of FIG. 1, having a circular cap closure;

FIG. 27 illustrates an isometric view of the carton, of FIG. 25, with the cap closure fitted thereon and in its closed configuration;

FIG. 28 illustrates an isometric view of the carton, of FIG. 26, with the cap closure in its open configuration;

FIG. 29 illustrates an isometric exploded view of a carton, of FIG. 1, having an oval cap closure;

FIG. 30 illustrates an isometric view of the carton, of FIG. 29, with the cap closure fitted thereon and in its closed configuration; and

FIG. 31 illustrates an isometric view of the carton, of FIG. 30, with the cap closure in its open configuration.

LIST OF REFERENCE NUMERALS USED IN
DETAILED DESCRIPTION AND DRAWING

| | |
|---|---|
| 10 | fluid dispenser |
| 100 | carton |
| 105 | blank |
| 110 | fitment hole |
| 115 | depression |
| 120A | first fold lines |
| 120B | second fold lines |
| 120C | third fold lines |
| 125A, 125B, | side panels |
| 125C, 125D | |
| 130 | top of carton |
| 130A | first top panel of the carton |
| 130B | second top panel of the carton |
| 132A, 132B | ear flap |
| 135 | base of the carton |
| 137A | first base panel of the carton |
| 137B | second base panel of the carton |
| 140A | fitment spout |
| 140B | cap closure |
| 150 | dispensing pump |
| 160 | circular cap closure |
| 170 | oval cap closure |
| 200 | nozzle for dispensing fluids |

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “including,” and “having,” are open ended transitional phrases and therefore specify the presence of stated features, integers, steps, operations, elements and/or components, but do not forbid the presence or addition of one or more other features, integers, steps, operations, elements, components, and/or groups thereof.

As used herein, the term “and/or” includes any and all combinations of one or more of the associated listed elements.

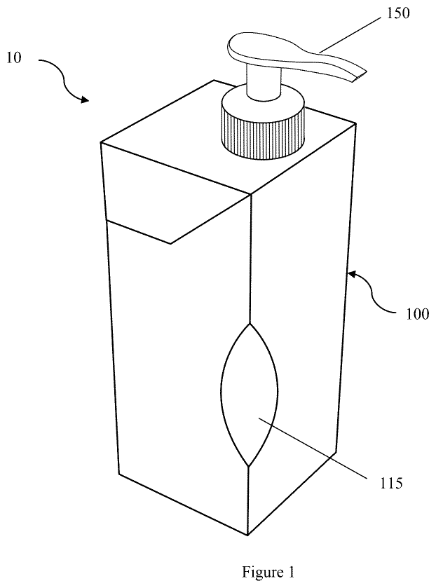

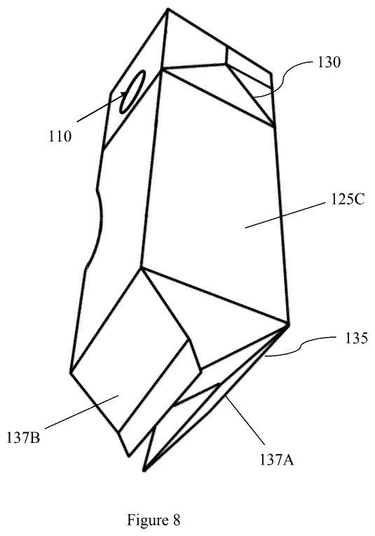

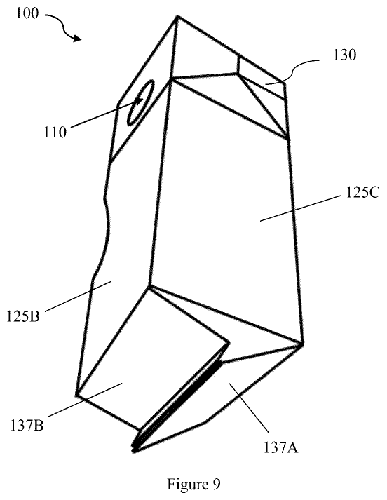

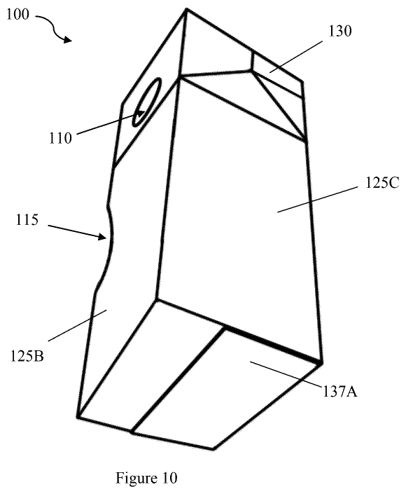

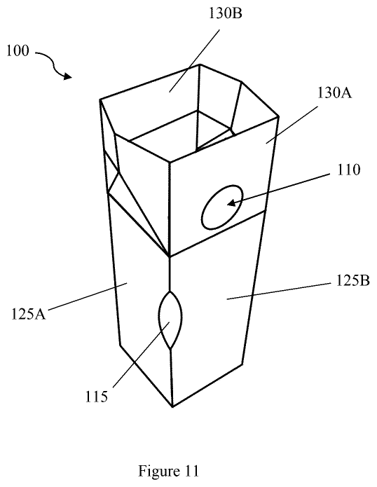

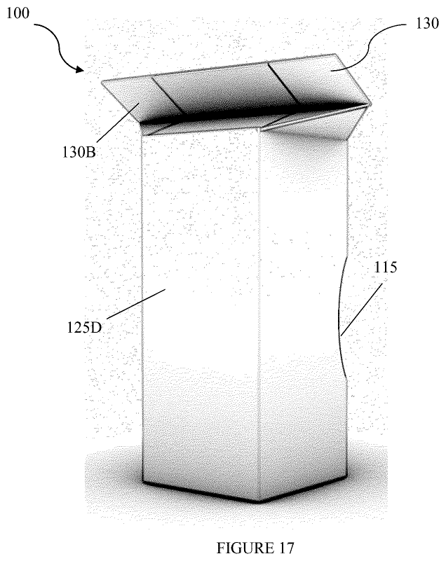

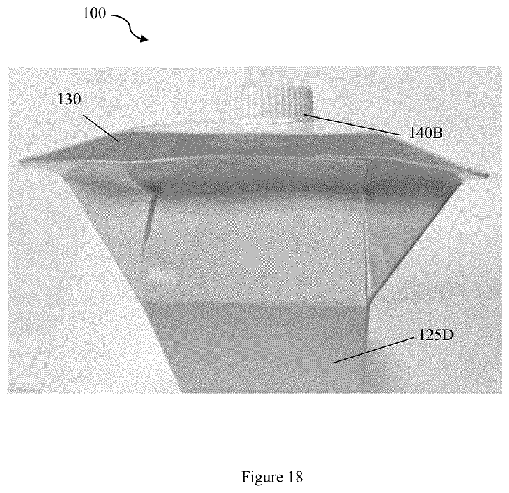

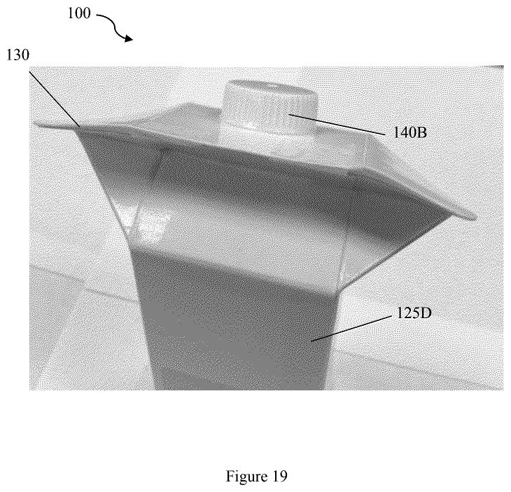

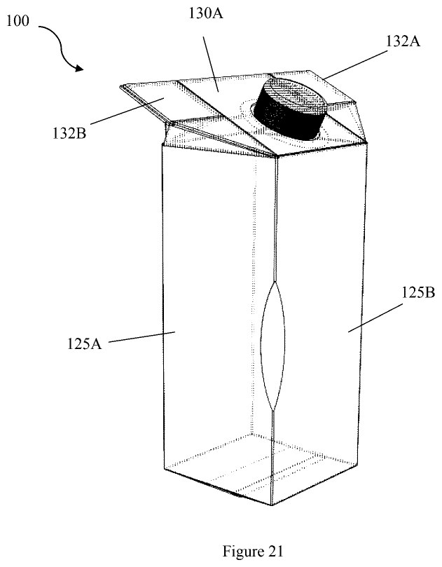

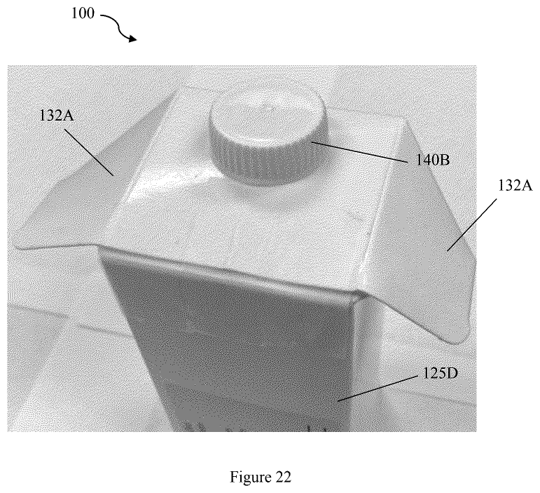

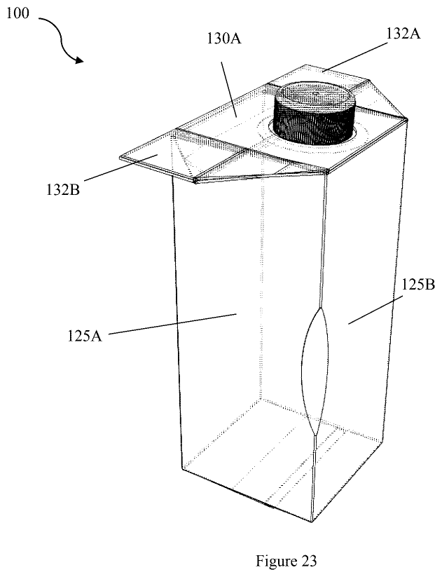

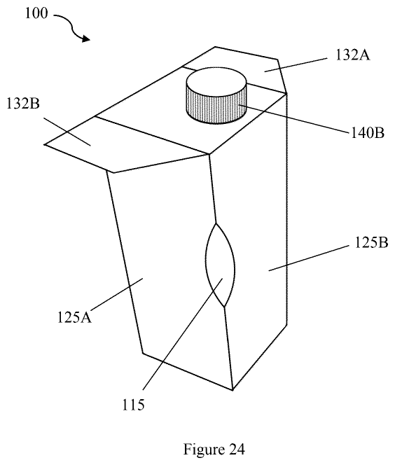

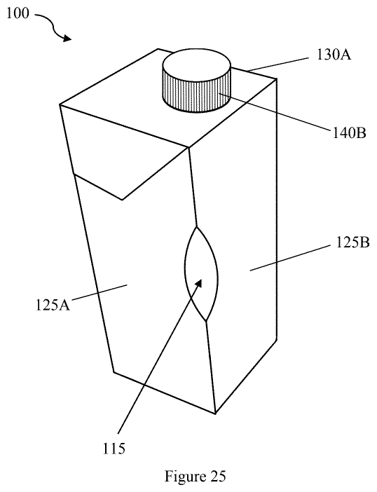

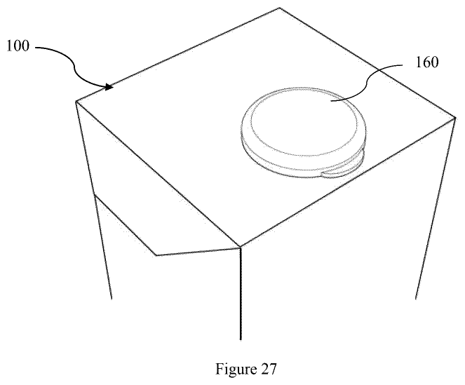

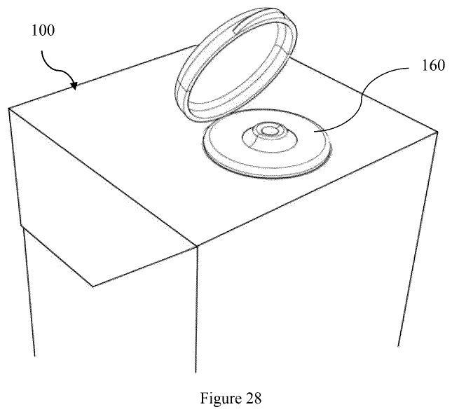

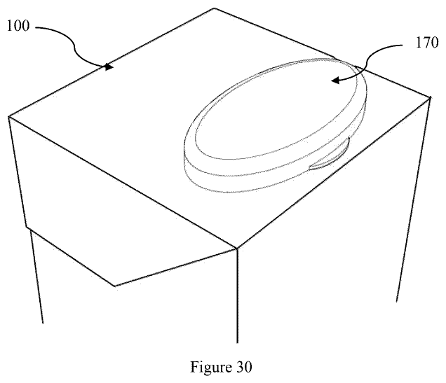

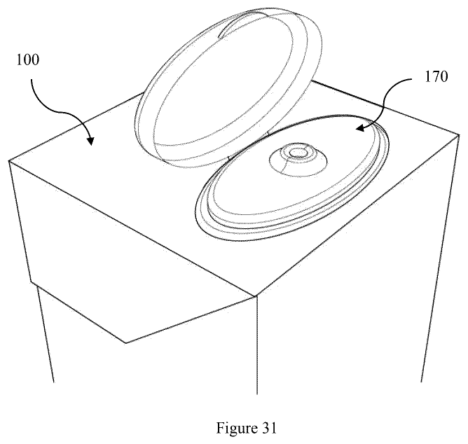

A fluid dispenser (10), of the present disclosure, will now be described in detail with reference to FIG. 1 through FIG. 31.

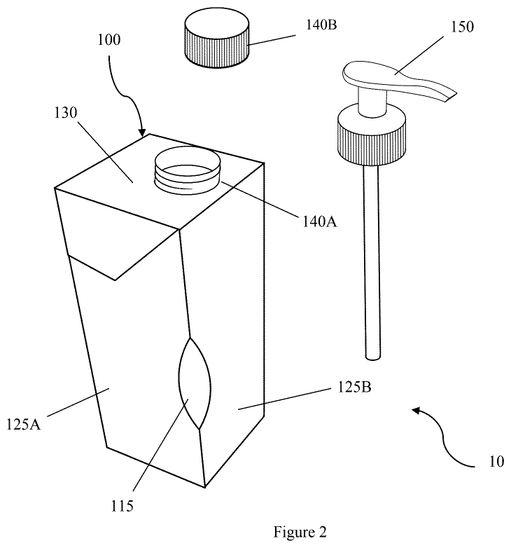

FIG. 1 illustrates the fluid dispenser (10) (hereinafter referred to as ‘the dispenser (10)’). FIG. 2 illustrates an exploded view of the dispenser (10) of FIG. 1.

The dispenser (10) comprises a carton (100) configured to store fluid therein. The carton (100) is formed from a laminated blank folded to form a set of sections which in their operative folded configuration are folded towards each other using a machine folding process to form base panels (137A, 137B), side panels (125A, 125B, 125C, 125D) and top panels (130A, 130B) of the carton, wherein the top panels (130A, 130B) form a multilayered resisting platform against deforming forces applied from top.

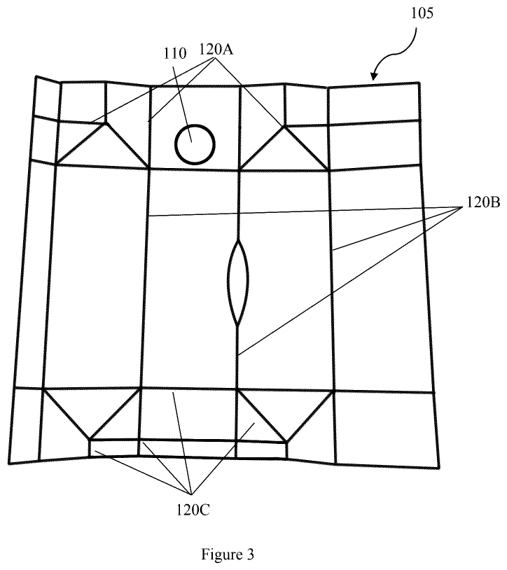

FIG. 3 illustrates a blank (105) for the dispenser (10) of FIG. 2.

In an embodiment, the blank is made from a packaging substrate is of a partially recyclable or completely recyclable material that is not only light in weight but also eco-friendly and is non-toxic.

In another embodiment, the packaging substrate comprises a plurality of layers including a layer of paper board and a composite layer. The substrate is laminated by at least one outermost polyethylene layer provided on both the inner surface and the outer surface of the substrate. The different layers of the substrate contribute to the above desired characteristics and further can be used to make the dispenser (10) last till at least four refills.

In an embodiment, rolls of a packaging substrate are passed through a cutting machine that cuts out blanks (105) of the desired shape from the substrate.

In an embodiment, the composite layer acts as an oxygen barrier to prevent reaction of outside air with the fluid stored in the dispenser (10). The polyethylene layer helps prevent seepage of the fluid from inside the carton (100). In an embodiment, the polyethylene layer provided on operative outer surface of the substrate helps in binding the side panels (125), and the bottom panels (137A, 137B) and top panels (130A, 130B) with each other, thus eliminating need for dependence on adhesives for binding. In another embodiment, the panels are heat sealed with each other, wherein the heat sealing is enabled by the polyethylene layer. The configuration of the blank (105) as mentioned above, helps in making the carton eco-friendly.

In one embodiment, the paper board has varying thicknesses varying between 0.35 mm to 0.60 mm depending on the cross section or size.

In one embodiment, the polyethylene layer can vary in thickness depending on the paperboard thickness. In yet another embodiment, the polyethylene layer provided on the outer surface can also vary in thickness depending on the paperboard thickness.

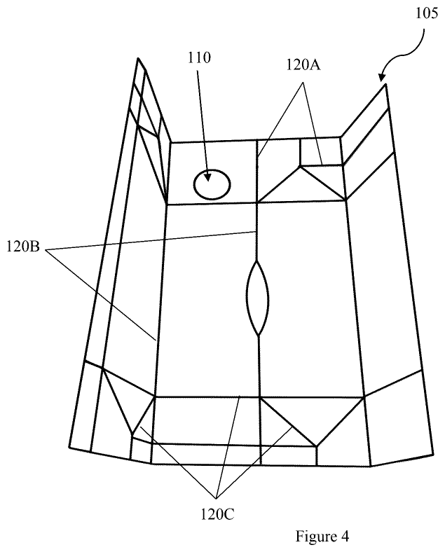

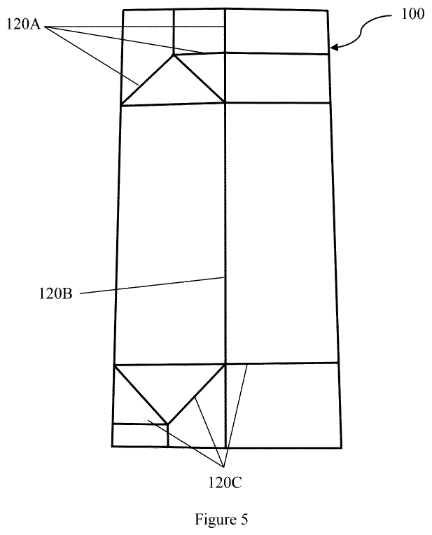

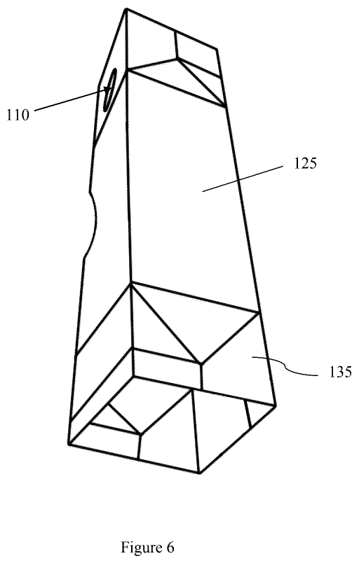

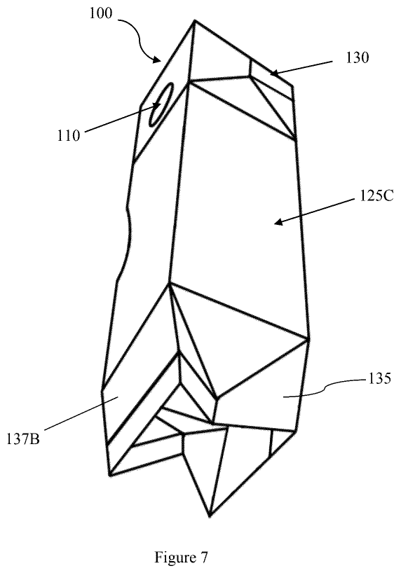

In an embodiment, the blank (105) has a set of first fold lines configured thereon to extend from an operative top edge of the blank (105) to an operative bottom edge of the blank (105), a set of second fold lines configured on an operative bottom portion of the blank (105), and a set of third fold lines configured on an operative top portion of the blank (105). The blank (105) is configured to be folded along the first fold lines to define side panels (125A, 125B, 125C, 125D) of the carton (100). FIG. 4 illustrates the blank (105) of FIG. 3 in a partially-folded configuration. FIG. 5 illustrates the blank of FIG. 4 in a folded configuration defining a sleeve. The side panels (125), after being folded, are attached to each other as shown in FIG. 6 to form an open carton. The blank (105) further is configured to be folded along the second fold lines to define a first base panel (137A) and a second base panel (137B) of the carton (100), and along the third fold lines to define a first top panel (130A) and a second top panel (130B) of the carton (100). The first base panel (137A) is configured to be folded over the second base panel (137B) to form a flat base (135) of the carton (100), as shown in FIG. 7 through FIG. 12. The first top panel (130A) is configured to be folded over the second top panel (130B) to form a substantially rigid flat top (130) of the carton (100).

The dispenser (10) further comprises a depression (115) configured on the carton along a longitudinal fold line defined between a first side panel (120A) and a second side panel (120B). The depression (115) allows locating of the thumb of a user thereon while gripping the carton (100). The depression (115) also prevents slippage of the carton (100) while being gripped by the user.

A fitment hole (110) is configured on the first top panel (130A) by punching method or otherwise defined at a predetermined location on the first top panel (130A).

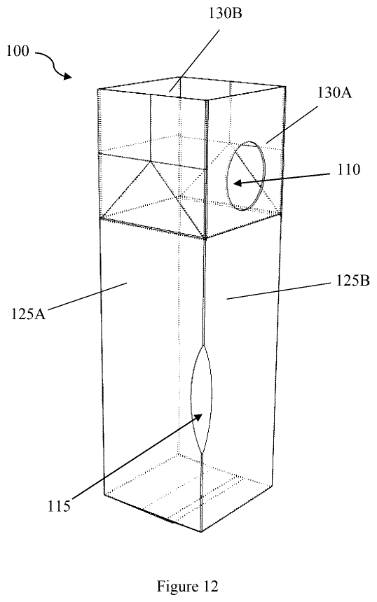

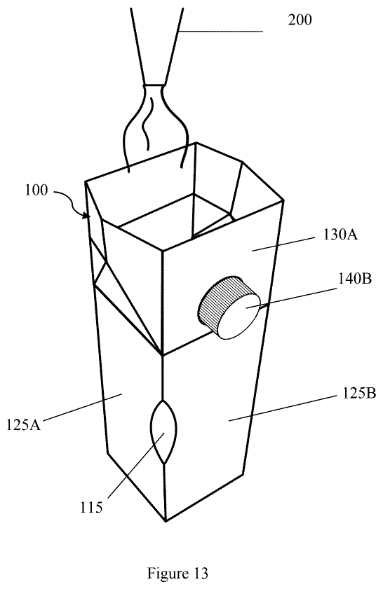

As shown in FIG. 13, the fitment unit, consisting of a fitment spout (140A) and a cap closure (140B), is fitted through the hole (110) and attached to the carton (100). In an embodiment, the fitment spout (140A) includes a flange which is fused to the insides of the carton (100). In another embodiment, the fitment spout (140A) is welded to the insides of the top portion of the carton (100). As shown in FIG. 12, a cap (140B) may be threadably and/or sealably engaged with the fitment unit.

In an operative configuration, once the base is formed and the fitment spout (140A) is attached to the carton, the carton (100) is placed beneath a nozzle (200) dispensing a fluid, as shown in FIG. 12, to fill the carton (100) to a desired volume.

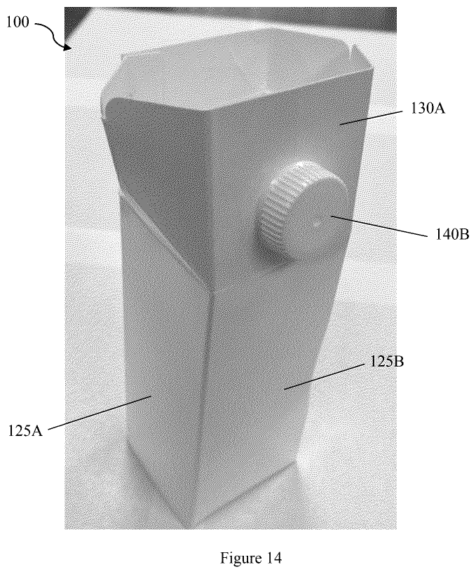

Only thereafter, is the formation of the top of the carton (100) initiated, as shown in FIG. 14 through FIG. 25.

The formation of the top of the carton is described as below:

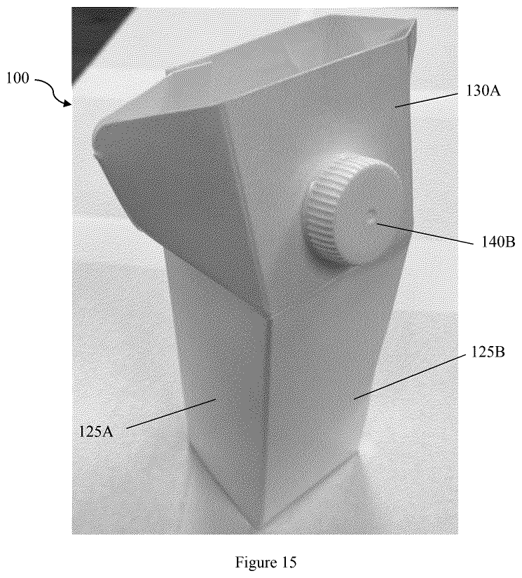

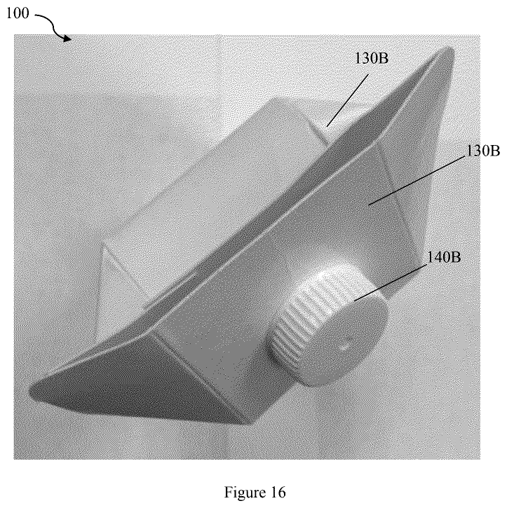

The set of third fold lines configured on an operative top portion of the blank (105) is folded according to a predefined sequence such that the first top panel (130A) overlaps the second top panel (130B). FIG. 15 shows the first top panel (130A), having the fitment and cap unit, about to be folded and pressed on the second top panel (130B). FIG. 16 through FIG. 19 shows the first top panel (130A) folded and pressed on top of the second top panel (130B). The top panel (130A, 130B) are attached to each other by heat sealing.

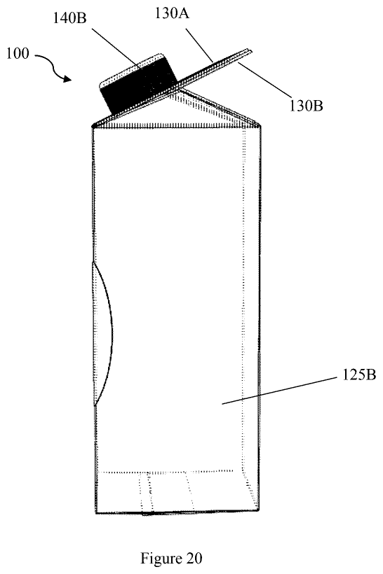

When pressed, the top portions (130) form a flat top of the carton (100) along with ear flaps (132A, 132B) extending out of the carton periphery (as seen in FIGS. 20 through 23). The ear flaps (132A, 132B) are affixed to the side body panels (125A, 125C) of the carton (100) to make the carton (100) as illustrated in FIG. 20.

In yet another embodiment, the panels (125,130, 135) are attached by heat sealing or by other sealing methods.

The dispenser (10) further comprises a fitment unit mounted on the fitment hole (110) to facilitate fluid dispensation therethrough. The dispensing pump (150), as shown in FIG. 2, is threadably attached to the fitment unit (140) to form the fluid dispenser (10). The pump (150) can be detached to allow a user to refill the dispenser (10) the cap (140B) may be removed from the fitment unit (140) prior to attachment of the pump (150) to the fitment unit (140).

In an embodiment, the second fold lines and the third fold lines include longitudinal, angular and transverse lines. In another embodiment, the section of the carton for the second top panel (130B) is configured to be folded along a transverse fold line to form a bi-layered second top panel (130B).

In an embodiment, the configuration of the first top panel (130A), when folded over the second top panel (130B), forms a multi-layered reinforced surface configured to resist deforming pumping forces in an operative configuration of the dispensing pump (150). More specifically, the multiple layers are defined by two layers formed by folding the second top panel (130B) over itself, and the third layer is formed by the first top panel (130A) overlapped on top of the second top panel (130B). The multilayered resisting platform formed by the top panels (130A, 130B) is not only an anti-deforming platform but is also resilient in nature as it dampens the deforming forces applied from the top, thereby maintaining the integrity of the carton (100). Resistance to deformation to the pumping forces is essential especially because the carton (100) is made of recyclable material that can easily crumple under such forces. Further, an air gap is defined by the panels (130A, 130B) that gives the resilient effect.

In an embodiment, the ratio of the overall width of the carton (100) to the distance between the free top edge of second top panel (130B) and the transverse fold line of the second top panel (130B) lies in the range of 0.45 to 0.53. In another embodiment, the dimension of the hole is half the overall width of the carton (100).

The result of such configuration and geometry of the fold lines and the dimensions of the hole (110) eliminates the need for configuring more than one fitment hole (110) on the top portion of the blank (105). More specifically, when the second top panel (130B) is folded along the transverse fold line, the folded second top panel (130B) does not come below the outline of the hole (110). As a result, there is no need for punching a hole on the second top panel (130B) as well. Further, any issues related to weakening of the substrate due to punching it is also reduced.

In an embodiment, the dispenser (10) is configured to dispense fluids or semi-fluids such as water, juices, milk and oil or slurries that include semi-viscous fluids such as soap slurries, adhesives, food pastes, gels, creams and lotions.

In an embodiment, the dispenser (10) is configured to be manufactured industrially in bulk amounts with the help of automatic machines.

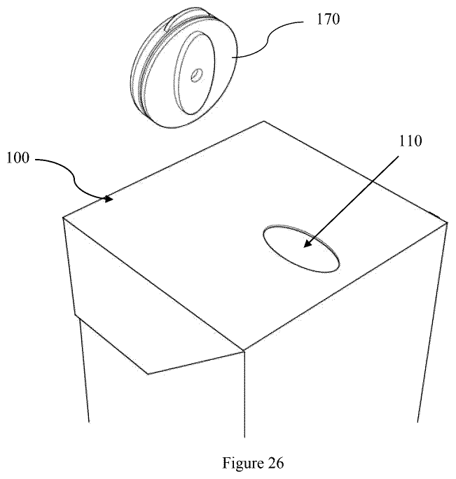

In one embodiment, as shown in FIG. 26 through FIG. 28, the cap closure (140B) has a circular configuration. The fitment hole (110) has a circular configuration to complement the configuration of the cap closure (160).

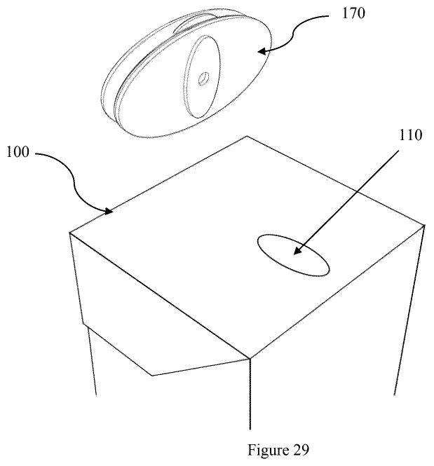

In another embodiment, as shown in FIG. 29 through FIG. 31, the cap closure (140B) has an ovular configuration. The fitment hole (110) has an oval configuration to complement the configuration of the cap closure (160).

The present disclosure also envisages a process of making a fluid dispenser (10). The method comprises the steps:
a) preparing a blank (105) from a laminated recyclable substrate;
b) punching a fitment hole (110) at a predetermined location on an operative top portion of the blank (105);
c) stamping a set of first fold lines (120A) on the blank (105), such that the first fold lines (120A) extend from an operative top edge of the blank (105) to an operative bottom edge thereof,
d) stamping a set of second fold lines (120B) on an operative bottom portion of the blank (105);
e) stamping a set of third fold lines (120C) on the operative top portion of the blank (105);
f) stamping a depression on a first fold line;
g) folding the set of first fold lines (120A), by a machine folding process, to define side panels (125A, 125B, 125C, 125D);
h) securing longitudinal edges of end side panels (125A, 125D) with each other to form an open carton (100);
i) folding the set of second fold lines (120B) in a predetermined sequence to form a pair of base panels (137A, 137B);
j) folding the first base panel (137A) over the second base panel (137B);
k) heat sealing the bottom flaps (137A, 137B) with each other to form a closed base (135) of the carton (100);
l) mounting a fitment unit on the fitment hole (110);
m) filling the carton (100) with a predetermined volume of a fluid;
n) folding the set of third fold lines (120C) in a predetermined sequence to define a pair of top panels (130A, 130B);
o) heat sealing the top panels (130A, 130B) with each other;
p) displacing the top panels (130A, 130B) in an operative downward direction such that the first top panel (130A) overlaps the second top panel (130B) and defines a pair of ear flaps (132A, 132B) extending therefrom;
q) abutting the ear flaps (132A, 132B) with the side panels (125A, 125C), and heat sealing the ear flaps (132A, 132B) with the side panels (125A, 125C) to define a substantially rigid flat top of the carton (100).

In an embodiment, step (a) includes a pre-step of preparing blank (105) from a packaging substrate comprising an innermost layer of paper board, an intermediate composite layer, and at least one outermost polyethylene layer provided on operative inner surface and operative outer surface of the substrate.

In another embodiment, step (h) includes a sub-step of heat sealing the longitudinal edges of end side panels (125A, 125D).

In yet another embodiment, step (I) includes a sub-step of mounting a fitment spout (140A), of the fitment unit, on the fitment hole (110).

In still another embodiment, step (I) includes a sub-step of welding the fitment spout (140A), of the fitment unit, on the fitment hole (110).

In another embodiment, step (i) includes a sub-step of threadably engaging a cap closure (140B) on the fitment spout (140A).

In yet another embodiment, step (i) includes a sub-step of sealably engaging a cap closure (140B) on the fitment spout (140A).

In still another embodiment, step (o) includes a sub-step of threadably mounting a dispensing pump (150) on the fitment spout (140A).

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

### Technical Advancements

The present disclosure described herein above has several technical advantages including, but not limited to, the realization of a fluid dispenser, which:
is resistant to deforming forces applied from above the dispenser, especially during pumping;
can be industrially manufactured;
can be manufactured from recyclable materials;
can be manufactured by a process in an automatic machine; and
can be refilled.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1-21. (canceled)

22. A fluid dispenser (10) comprising:
a carton (100) configured to store fluid therein, said carton (100) being formed from a laminated blank folded to form a set of sections which in their operative folded configuration are folded towards each other using a machine folding process to form base panels (137A, 137B), side panels (125A, 125B, 125C, 125D) and top panels (130A, 130B, 130C) of the carton;
a fitment hole (110) configured on said first top panel (130A);
a fitment unit mounted on said fitment hole (110) to facilitate fluid dispensation therethrough, said fitment unit includes a fitment spout (140A) configured to be mounted on said hole (110);
wherein said fitment unit includes a dispensing pump (150) configured to be attached to said fitment spout (140A), said dispensing pump (150) configured to facilitate dispensation of the fluid through said fitment hole (110) in an operative configuration thereof; and
wherein said first top panel (130A), when folded over said second top panel (130B) forms a third top panel 130C, thereby forming a three-layered reinforced surface configured to resist deforming pumping forces in an operative configuration of said dispensing pump (150).

23. The fluid dispenser (10) as claimed in claim 22, wherein said blank is manufactured from a recyclable substrate comprising an innermost layer of paper board and an intermediate composite layer, said substrate being laminated by at least one outermost polyethylene layer provided on operative inner surface and operative outer surface of said substrate.

24. The fluid dispenser (10) as claimed in claim 22, wherein said sections are defined on said blank by a set of first fold lines (120A) configured to extend from an operative top edge of said substrate to an operative bottom edge of said substrate, a set of second fold lines configured (120B) on an operative bottom portion of said substrate, and a set of third fold lines (120C) configured on an operative top portion of said substrate.

25. The fluid dispenser (10) as claimed in claim 24, wherein said blank is configured to be folded along said first fold lines (120A) to define side panels (125A, 125B, 125C, 125D) of said carton (100), said substrate further being configured to be folded along said second fold lines (120B) to define a first top panel (130A) and a second top panel (130B) of said carton (100) and along said third fold lines (120C) to define a first base panel (137A) and a second base panel (137B) of said carton (100).

26. The fluid dispenser (10) as claimed in claim 25, wherein said first base panel (137A) is configured to be folded over said second base panel (137B) to form a flat base (135) of said carton (100).

27. The fluid dispenser (10) as claimed in claim 25, wherein said first top panel (130A) is configured to be folded over said second top panel (130B) and said third top panel (130C) to form a substantially rigid flat top of said carton (100).

28. The fluid dispenser (10) as claimed in claim 22, wherein a depression is configured on said carton (100) on a longitudinal fold line defined between the first side panel (125A) and the second side panel (125B).

29. The fluid dispenser (10) as claimed in claim 22, wherein said fitment spout (140A) is configured to be weldably mounted on said hole (110).

30. The fluid dispenser (10) as claimed in claim 22, wherein said fitment unit includes a cap closure (140B) configured to be fitted on said fitment spout (140A) in an inoperative configuration of said dispenser.

31. The fluid dispenser (10) as claimed in claim 30, wherein said cap closure (140B) is sealably engaged with fitment spout (140A) or wherein said cap closure (140B) is threadably engaged with fitment spout (140A).

32. The fluid dispenser (10) as claimed in claim 31, wherein said cap closure (140B) has a circular configuration.

33. The fluid dispenser (10) as claimed in claim 31, wherein said cap closure (140B) has an ovular configuration.

34. A process for making a fluid dispenser (10), said method comprising the steps:
a) preparing a blank (105);
b) punching a fitment hole (110) at a predetermined location on an operative top portion of said blank (105);
c) stamping a set of first fold lines (120A) on said blank (105), such that said first fold lines (120A) extend from an operative top edge of said blank (105) to an operative bottom edge thereof,
d) stamping a set of second fold lines (120B) on an operative bottom portion of said blank (105);
e) stamping a set of third fold lines (120C) on said operative top portion of said blank (105);
f) stamping a depression on a first fold line;
g) folding said set of first fold lines (120A), by a machine folding process, to define side panels (125A, 125B, 125C, 125D);
h) securing longitudinal edges of end side panels (125A, 125D) with each other to form an open carton (100);
i) folding said set of second fold lines (120B) in a predetermined sequence to form a pair of base panels (137A, 137B);
j) folding said first base panel (137A) over said second base panel (137B);
k) heat sealing said bottom flaps (137A, 137B) with each other to form a closed base (135) of said carton (100);
l) mounting a fitment unit on said fitment hole (110);
m) filling said carton (100) with a predetermined volume of a fluid;
n) folding said set of third fold lines (120C) in a predetermined sequence to define a pair of top panels (130A, 130B);
o) heat sealing said top panels (130A, 130B) with each other;
p) displacing said top panels (130A, 130B) in an operative downward direction such that said first top panel (130A) overlaps said second top panel (130B) and defines a pair of ear flaps (132A, 132B) extending therefrom;
q) abutting said ear flaps (132A, 132B) with said side panels (125A, 125C), and heat sealing said ear flaps (132A, 132B) with said side panels (125A, 125C) to define a substantially rigid flat top of said carton (100).

35. The process as claimed in claim 34, wherein step (a) includes a pre-step of preparing blank (105) from a recyclable substrate comprising an innermost layer of paper board and an intermediate composite layer, and is laminated by at least one outermost polyethylene layer provided on operative inner surface and operative outer surface of said substrate.

36. The process as claimed in claim 34, wherein step (h) includes a sub-step of heat sealing said longitudinal edges of end side panels (125A, 125D).

37. The process as claimed in claim 34, wherein step (I) includes a sub-step of mounting a fitment spout (140A), of said fitment unit, on said fitment hole (110).

38. The process as claimed in claim 34, wherein step (I) includes a sub-step of welding said fitment spout (140A), of said fitment unit, on said fitment hole (110).

39. The process as claimed in claim 38, wherein step (i) includes a sub-step of threadably engaging a cap closure (140B) on said fitment spout (140A).

40. The process as claimed in claim 38, wherein step (i) includes a sub-step of sealably engaging a cap closure (140B) on said fitment spout (140A).

41. The process as claimed in claim 34, wherein step (o) includes a sub-step of threadably mounting a dispensing pump (150) on said fitment spout (140A).
